(19) United States
(12) Patent Application Publication
(10) Pub. No.: US 2008/0208873 A1
(43) Pub. Date: Aug. 28, 2008

(54) Method for communicating confidential, educational information

(76) Inventor: Daniel R. Boehmer, Herndon, VA (US)

Correspondence Address: DICKSTEIN SHAPIRO LLP, 1825 EYE STREET NW, Washington, DC, 20006-5403, US

(21) Appl. No.: 12/071,398

(22) Filed: Feb. 20, 2008

Related U.S. Application Data
(63) Continuation of application No. 10/475,495, filed on May 17, 2004, now abandoned.
(60) Provisional application No. 60/287,336, filed on May 1, 2001.

(51) Int. Cl. G06F 17/30

(52) U.S. Cl. 707/10; 707/E17.008

(57) ABSTRACT

A method for receiving, processing, and responding to requests relating to educational degree, enrollment, transcript, and loan information via secured and non-secured channels. In a disclosed embodiment, a requestor submits an order to verify degree or enrollment information consisting of a student's first name, last name, and/or social security number. A computer at a Clearinghouse matches the order with data compiled from participating educational institutions and generates a response. Enrollment information can include both current attendance and historical information. Optionally, degree information can be maintained in a separate database. Requestors can also order up-to-date student transcripts via the Clearinghouse.

### CONTINUING DATA

This is a utility application derived from U.S. provisional patent application Ser. No. 60/287,336 filed May 1, 2001.

### FIELD OF THE INVENTION

A student and school information system and process for verifying enrollment, degrees, loan information and transcript data.

### BACKGROUND OF THE INVENTION

Verifying student degrees and other educational achievements in higher education is fragmented among more the 3,600 degree granting institutions across the United States. This fragmentation has given rise to a number of problems. First, there is a tremendous administrative workload burden created by fragmented education information verification programs. In a typical university registrar's office, a number of employees are constantly being interrupted by telephone calls from employers, employment background agencies, and recruiting firms that call to verify the degrees granted to their prospective employees. As prospective employees are the institution's alumni, registrars are generally willing to drop everything and verify degrees in order to insure that they are not the cause of their alumni losing out to job candidates from other colleges (who are more responsive to supplying the requested information).

Moreover, since September 11th, the number of verification requests has dramatically increased. Employers are now more careful and are increasing their emphasis on thorough background checks—including educational background data. Thus, the pure volume of requests to a registrars' office has increased its administrative burden dramatically.

Second, disjointed and fragmentary information sources lead to fraud and misrepresentation. Some job applicants take the chance that false degree claims will go undiscovered. By some industry estimates, employers verify fewer than 30% of degree claims made by prospective employees. For many employers it is simply too cumbersome to sort though the process of locating the right telephone numbers in order to contact the correct offices in schools that prospective candidates say they attended.

Third, current fragmented systems cannot be measured for performance. Educational institutions, the federal government, state legislatures, governing boards and other entities that provide funding to institutions of higher education having a strong interest in assessing the educational success or outcomes that are achieved. However, institutions are unable to determine their true graduation or completion rates because they are often unable to identify and count those students who transfer and obtain their degrees from other institutions. Thus, the lack of a centralized repository for educational information results in the failure of educational institutions being able to measure their true success.

The student enrollment verification problem is virtually identical to the student degree verification problem. Enrollment data, like degree data, is spread across more than 3,600 degree granting institutions. It is difficult for the holders of the data such as the schools, to connect to the entities that need the data (primarily employers).

To complicate the issue of verification, various privacy laws including (Federal Family Educational Rights And Privacy Act, 20 U.S.C. §1232(g)) (hereinafter “FERPA”) require further college administrative oversight. Not only does the institution have to answer the many requests for student enrollment and degree information, but it also must have an awareness of whether or not the student has requested that their information remain private.

Finally, the university's administrative record keeping function must be tied to university billing. Sometimes the only leverage that a university has with a student or former student, is to withhold a degree, future enrollment, or other information from the student or would-be-employer, until the university's financial requirements are cleared. That requires coordination. To the extent that such coordination can be resolved administratively, money, time, and people must be deployed. These are things that universities do not have.

### SUMMARY OF THE INVENTION

The above problems are overcome by means of a Clearinghouse that uses databases containing degree, transcript, loan, enrollment and other education-related information. As contemplated, the present invention provides for a Clearinghouse processor and database incorporating enrollment and up-to-date degree data. The database regularly receives from university and college registrars employer-directed requests asking for degree credentials to be verified as well as enrollment information. By virtue of creating a centralized automated computerized educational information system, employers, loan agencies, credentialling organizations and any other degree or enrollment or transcript verification source can substitute one telephone number and/or one website to obtain degree information for all higher educational institutions. Under such a system, the huge administrative and financial burdens that schools, colleges and universities have for such activities would be dramatically reduced, often free of charge. Moreover, fraud and misrepresentation will be avoided and the speed of accurate information to employers would be dramatically increased.

### BRIEF DESCRIPTION OF THE DRAWINGS

The foregoing aspects and many of the above advantages of this invention will become more readily appreciated as it becomes better understood by reference to the following detailed description when taken in conjunction with the accompanying drawings, wherein:

FIG. 1 is a block flow diagram illustrating the overall navigational architecture of the education information Clearinghouse 100;

FIGS. 2A-B are flow diagrams of the functions of the college and university portion of the Clearinghouse set forth in FIG. 1;

FIG. 3 is a flow diagram that illustrates the guarantors, lenders and servicers functions of the Clearinghouse;

FIG. 4 is a flow diagram that discloses the secure enrollment verify functional elements of the present embodiment;

FIG. 5 is a flow diagram that illustrates the functional elements and data aspects of the degree verify process and system for secure password protected site users of the present embodiment;

FIG. 6 is a flow diagram that illustrates the password protected student user functions for loan-based searches of the present embodiment;

FIG. 7 is a block flow diagram illustrating the non-secure guarantor and lender system and process functions of the present embodiment;

FIG. 8 is a block flow diagram showing the non-secure college and university degree and enrollment website functions of the present embodiment;

FIGS. 9A and 9B are process flow diagrams illustrating the degree verify functions (overview) performed on requester data of the present embodiment;

FIG. 10 is a detailed flow diagram whereby a requester submits a request for a degree for degree verification schools forming the present embodiment;

FIG. 11 is a flow diagram illustrating the enrollment verification part of the degree verification service or system whereby the requestor submits an enrollment-only verification request;

FIG. 12 shows the process or system that relates to FIG. 2 in more detail with respect to the school user closing out a pending case;

FIG. 13 illustrates the Clearinghouse process flow and system for dealing with pending cases provided to the colleges and universities shown in FIG. 12; and

FIG. 14 illustrates the Clearinghouse closing out an awaiting case with an Ad Hoc submission.

### DETAILED DESCRIPTION OF THE PREFERRED EMBODIMENT

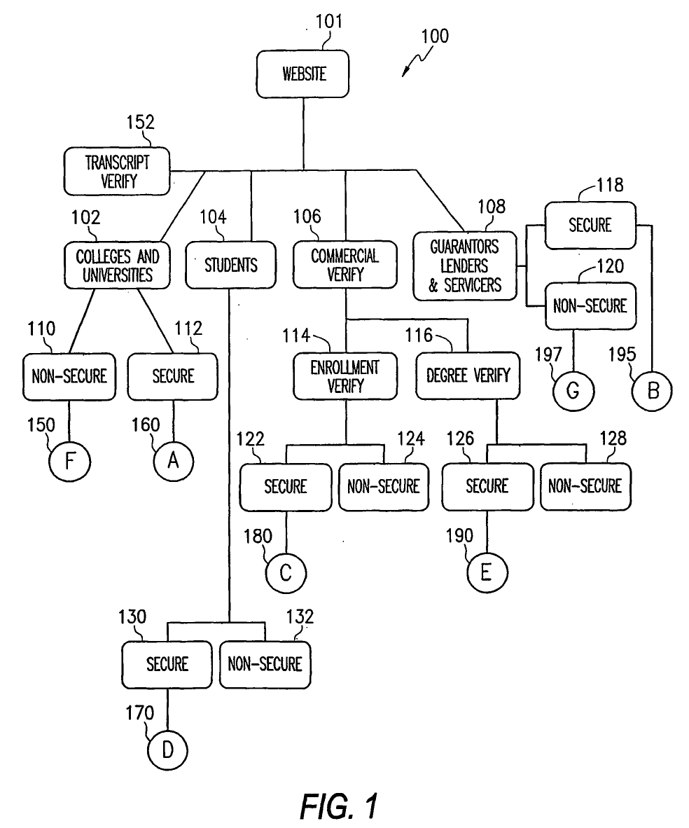

Referring now to the drawings wherein like reference numerals refer to like elements, FIG. 1 illustrates an overall process and system for the Clearinghouse 100.

The Clearinghouse 100 is modeled on the concept of a “reported once” enrollment verification system or service. To be successful, the current system involves a number of participants: First, universities or other educational institutions 102; second, commercial requestors 106; third, students 104; and fourth, guarantors lenders and servicers 108.

Universities and colleges 102 are able to integrate data on educational degrees granted based upon die university reporting procedures. The university or college 102 transmits any additional information containing all degree data available on electronic media (e.g. FTP, internet, tape, cassette magnetic, optical) or any other conventionally known media. Moreover, it is expected that the colleges and universities will transmit data on newly granted educational degrees shortly after each is conferred. Colleges and universities 102 are issued passwords (not shown) to which FTP degree files containing the same password are used to transmit enrollment data files.

For universities and colleges 102, once the Clearinghouse 100 has been appointed as the agent and has begun reporting degree data, it can respond to various requests from either students 104, commercial entities 106, or guarantors, lenders and servicers 108, for information verification. Users may choose from a range of options in redirecting various requests. For example, some institutions can appoint the Clearinghouse 100 as its exclusive source of degree and enrollment verification information. Alternatively, educational institutions can participate only to the extent that they provide enrollment verification to commercial entities 106. At another level, educational institutions can be listed in a separate part of the database simply to verify enrollment data to guarantors, lenders, and servicers 108. The present invention can encompass any memory device or architecture to accommodate the different permission-levels affiliated with each institution.

It is anticipated that the Clearinghouse 100 will use a variety of methods for distributing educational information, such as enrollment and degree verification data efficiently. Such methods include using a secure, (password protected) website, a public website, an extranet to requestors and educational institutions 102, email, telephone, fix, XML or (web services) and batch file processing. It is anticipated that the Clearinghouse can comprise any known arrangement of computer hardware, connected to the Internet along with any LAN architecture, or WAN architecture that is commercially known or used. Conventional arrangements can include but not be limited to a server-based platform connected to the Internet, a local area network, a PBX for the telephone exchanges, and conventionally known fax equipment.

Commercial customers 106 will typically request information from the Clearinghouse 100. It is expected that such requestors 106 are either employers, certification organizations or credential checking companies. However, the present invention is not meant to be limiting regarding the type of commercial enterprise requesting access. Usually, requestors 106 will make their first contact to the Clearinghouse 100 by phone or by email or through the website 101. Once it is agreed that the requestor will become a member and will pay the Clearinghouse 100 transaction fees, the requestor 106 is issued a password in order to use the system 100 to confirm educational information. In order to ensure that students and alumni are not prejudiced by an requestor's unwillingness to pay a nominal transaction fee, requestors that do not wish to pay that fee can be asked to submit a separate written request for each data verification that they desire. Such requests will then be handled along the non-secure side of the website at 124.

It is anticipated that the present system or service will be designed as an educational verification source. Therefore, the accuracy of certain information may not be obtained by the Clearinghouse. For these issues to be resolved, and the data to be confirmed, the requestor will either need to check its records, request more information from the former student, or inquire directly with the educational institution 102. Moreover, there will be a number of circumstances, as described in the figures below, where the date of the student's degree pre-dates the degree data that the institution 102 transmits. Obviously, such circumstances will also result in a degree not being confirmed. Finally, the Clearinghouse 100 may simply be unable to locate the student with the information that the employer has provided. Obviously, some of those cases may be fraudulent degree claims, which the Clearinghouse 100 is designed to catch.

For colleges and universities therefore the Clearinghouse 100 will act as the agent to confirm or verify degree information. However, it is not the intent of the present invention for the Clearinghouse to act as the agent for universities and colleges in order to deny degree information. In the event that the Clearinghouse 100 is unable to verify requested information, it will contact the university 102 and ask it to perform the necessary research. At that point, the college or university 102 may work directly with the commercial requestor 106 to resolve problems or ambiguities. At the end of that analysis, however, the university 102 is urged to provide its research results to the Clearinghouse 100 so that it can communicate with the requestor and update its own database and so that the same discrepancy will not occur in the future.

All inquiries relating to college and university 102 provided information will contain an audit trail. Therefore, colleges and universities 102 will also be able to tale advantage of the full audit trail to determine who is accessing student information. As a result of the audit trail, student privacy will be insured.

A final advantage to college and universities is the simplification and enhancement of enrollment and degree reporting. The Clearinghouse 100 is able to provide colleges and universities 102 with an efficient way to determine when admitted students are transferred and the new university or college where that student actually enrolled. As a result, college and universities 102 can conduct an enrollment search and track students. Furthermore, for employers 106, institutional researchers can determine true and complete graduation rates by identifying degrees earned by students who leave that institution. College and universities 102 will also be able to use such a service to identify its graduates who obtained advanced degrees from other institutions.

It should be noted that the website 100 is designed to create a user account for each user who is allowed access to the system. If there are multiple users with the same degree or enrollment information, each user must have his or her own account. It should be noted, however, that any security scheme or password scheme can be employed by the present invention.

In the present embodiment, in order for a user to gain access to the degree of a student, several steps must be completed upon entering the website 101. The user will put in the user name as well as his or her identifying information (name, organization, user type, authorized profile tokens, email address and phone). Once on the website, a user can navigate to either the college/universities functions 102, the student request functions 104, the commercial verify functions 106, or the guarantors, lenders and servicers functions 108.

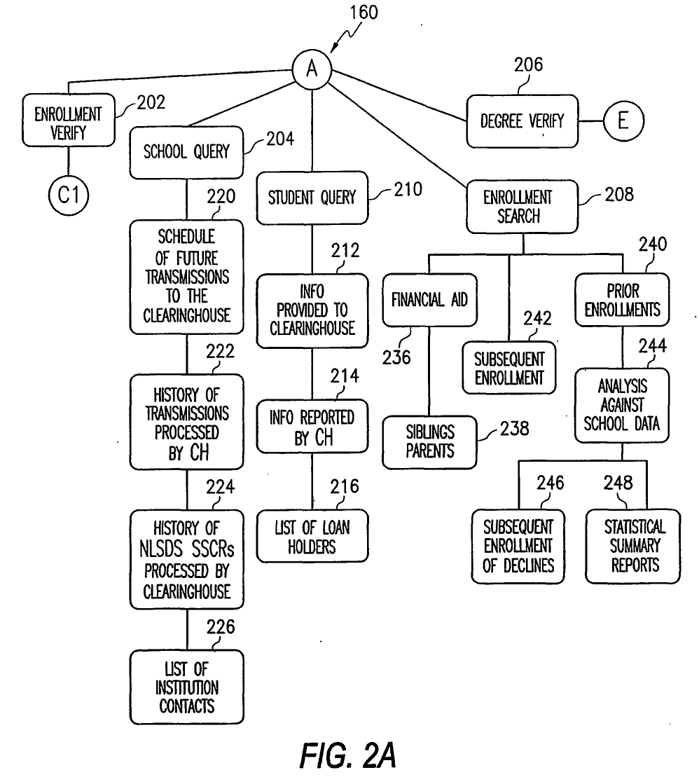

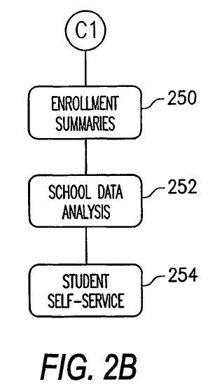

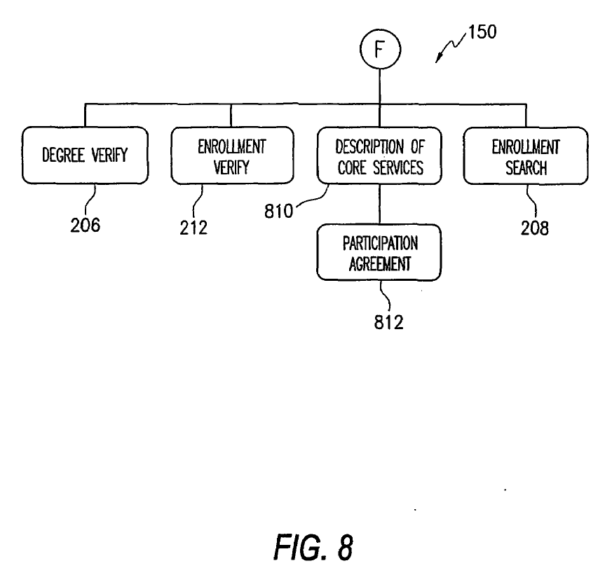

Under colleges and universities functions 102, two options exist: non-secured functions 110 or secure functions 112. Details of the non-secure functions are illustrated in FIG. 8 as process or system 150. The password-protected secure system or functions 112 is shown in FIG. 2, 160.

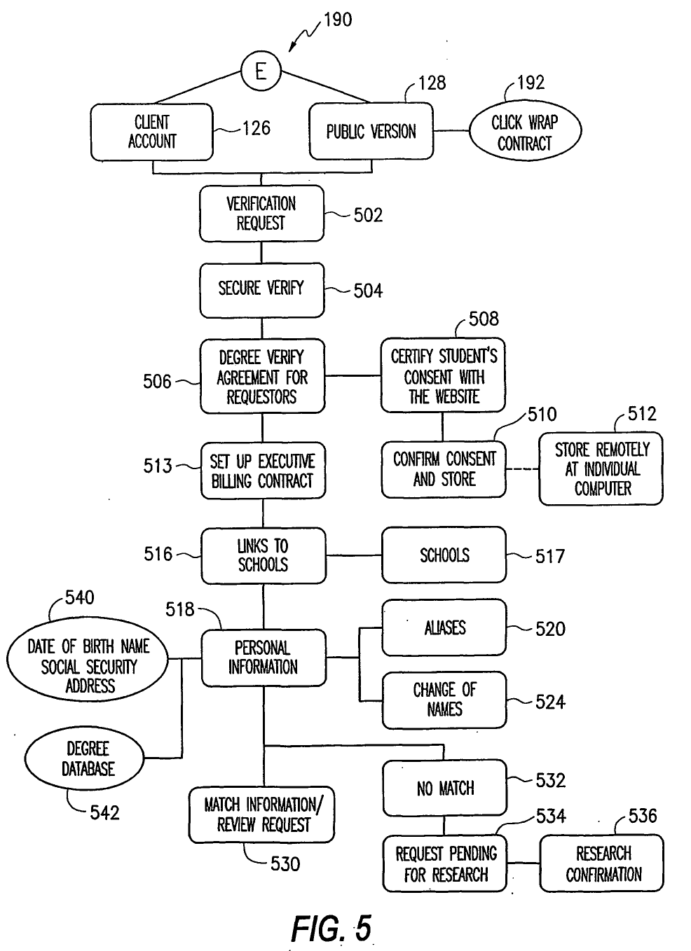

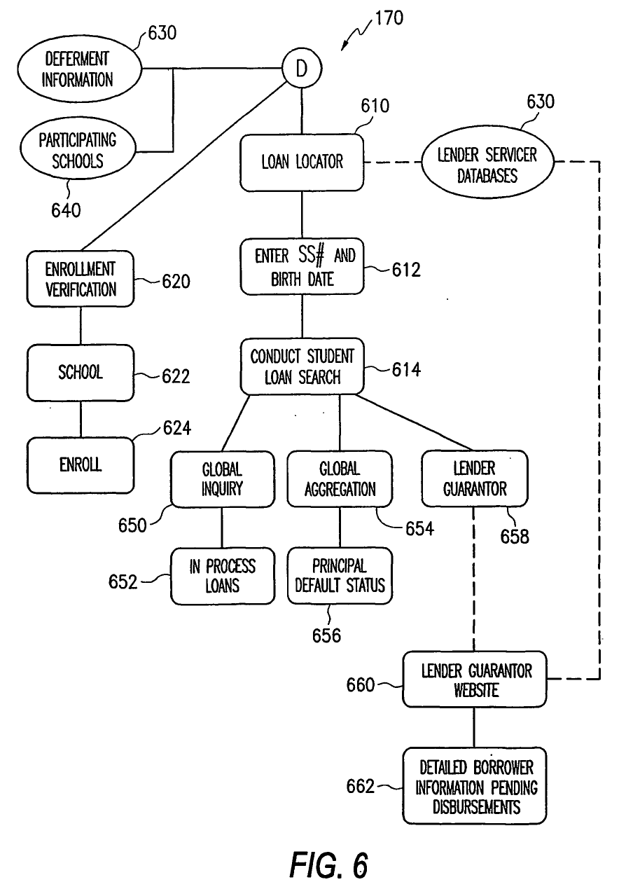

The students 104 can also access certain information through either a password-protected web-page 130 or other information contained on the non-secure page of the website 132. The secure side process or system is illustrated as process 170 in FIG. 6.

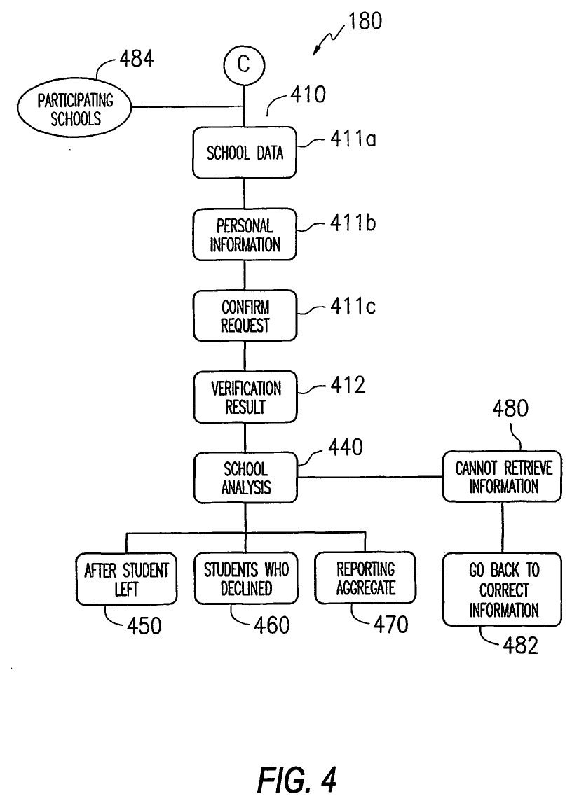

Commercial entities 106 can access two separate systems and services. The first service is the current enrollment verification process 114. The enrollment verify service or system 114 is typically used by credit issuers, health insurance companies, student housing providers and other commercial entities that supply student services and who need to verify current student enrollment. Two types of entities are capable of accessing this data 114: secure commercial entities 122 which can access data 114 through a password-protected web-page. The secure services 122 are illustrated as process 180 in more detail in FIG. 4 and non-secure services 124 which are similar to the secure services, but are paid for in advance (not shown).

The second service available to the commercial entities 106 is the degree verification service 116. Ideally the degree verification service is used by the prospective employer, background screening companies, executive search firms, and other organizations that need to verify academic credentials. The degree verification program/service 116 provides information on degrees awarded to a prospective candidate and that candidate's dates of enrollment. Two levels of access are provided: secure for password protected inquiries 126 and non-secure 128 for inquirers that pay on a per-transaction basis. The secure services 190 are illustrated in further detail in FIG. 5.

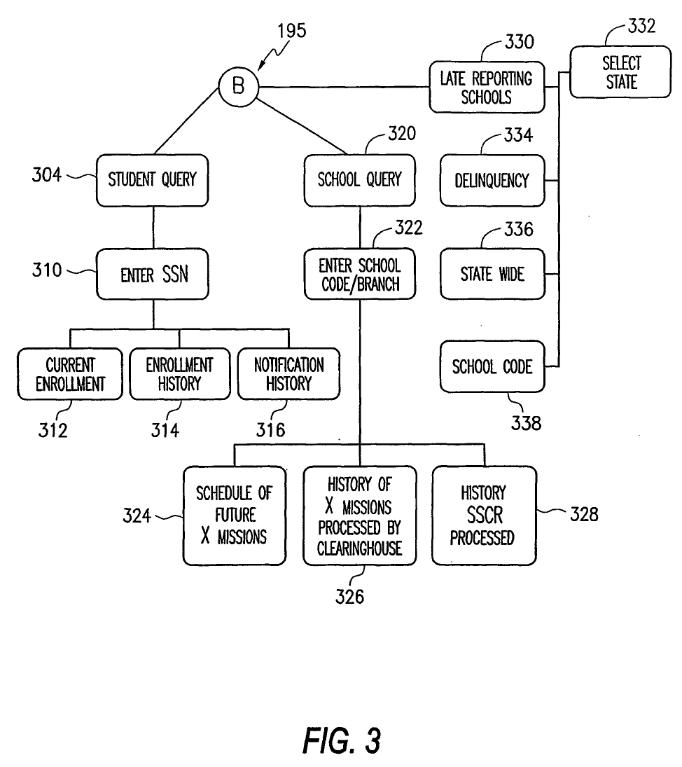

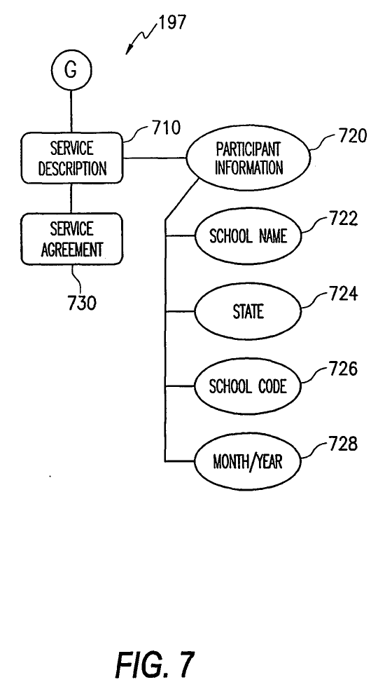

Guarantors, lenders, and loan servicers 108 can access information relating to a borrower's changing status. The purpose of this aspect of the website is to enhance a lender's services to schools and students and streamline the lender's, servicer's or guarantor's enrollment verification and deferment process. Lenders can either access a secure portion of the site 118 whose process 195 is illustrated in further detail in FIG. 3. Alternatively, the non-secure site 120 is further illustrated as process 197 in FIG. 7.

The Clearinghouse 100 also includes a transcript verification function 152. By accessing this feature, a requestor receives current and historical grade information for an identified candidate. Academic honors, or penalties (e.g. academic suspensions) are also reported.

FIG. 2 illustrates details regarding the secure site 160 of the Clearinghouse homepage 101 for colleges and universities 102. The purpose of the secure site 160 is to enable colleges and universities 106 to manage their relationships with the Clearinghouse. Additionally, this site can be used to manage college and university enrollments and verify relationships. These institutions can also query student loan data via a loan locator service for exit counseling purposes for its students. In addition, colleges and universities can view student level enrollment reporting and school level activity for student loans. Finally, a purpose of the secure site 160 is to perform enrollment research activity for retention and analysis purposes with regard to the previously mentioned enrollment search capability.

Specifically, five main functions are performed for colleges and universities: enrollment verify 202, school query 204, degree verification 206, enrollment searching 208, and student query 210. Information for all of the functions are provided from two data sources: a database resident at the school and a database located at the Clearinghouse 100.

The database located at the Clearinghouse consists of three levels of data: a group of schools that have agreed to provide degree certification information, a group of schools that provide enrollment verification for commercial inquiries (e.g. employers) and a group of schools that provide enrollment verification solely to student loan lenders, guarantors and servicers. The enrollment verify 202 enables a school 106 to view all of the web-based enrollment verifications conducted for that institution. In the student query section 210, the school can view both the degree and enrollment verification information that has been provided by that school to the Clearinghouse 212, and the information reported out by the Clearinghouse 100 for a given student. These features will be beneficial in enabling the school 106 to research and audit its degree and enrollment activities. The degree verify feature 206 enables the school 106 to open a variety of degree verification queries depending on the school's type.

A first step in the school website 102 involves the school entering its code or branch number which, when entered, allows that school to look at its degree verification data on a per-student basis. Another feature of the process or system 106 is the school query feature 204. The school query option 204 enables the school to obtain a schedule of future degree transmissions to the Clearinghouse 220. This scheduling function enables the school to provide a calendar and reminder based system between itself and the Clearinghouse 100. Therefore, those individuals administering degree information shall receive reminders from the Clearinghouse 100 either by e-mail, web-site messages or by other electronic means to update the Clearinghouse 100 based upon that school's academic calendar. The school query option 204 also includes a history of degree transmissions processed by the Clearinghouse 222 which allows the school to see all degree transmissions that have been updated in the Clearinghouse database. The fourth feature is a history of NSLDS and the SSCR's processed by the Clearinghouse 224.

The enrollment verification relationship function 202 includes two features that are shown in more detail in FIG. 2B. The first is a summary of enrollment verifications performed by the Clearinghouse for companies and individuals 250. The summary is a history of verifications that match the query criteria. Detailed information for a specific verification can be obtained by clicking on the student name. The column headings for the verification status chart include the date that the student was notified of the enrollment, the student's verification status, the student's social security number, the student's name and the name of the party requesting the enrollment verification. In addition, analysis against school data can be provided in step 252. This analysis can include subsequent enrollment of students who decline admission, the subsequent enrollment altogether, and statistical summary reports which can give the school various statistical data pertaining to a student's enrollment. A further feature of the enrollment verification is the summary of student self service enrollment verified options 254. This is a list of information from student enrollment inquiries to the particular school. A chart, similar to that found for the summary of prior enrollment verifications, is provided to the university for verification purposes.

Returning to FIG. 2A, the student query option 210 is available. Information in the student query falls into three groups: that information provided to the Clearinghouse 212, information reported out by the Clearinghouse 214 and the list of loan holders 216. The information provided to the requester by the Clearinghouse forms two-types of histories: (for the particular institution whose code has been matched 266) the student's degree information history for that institution or the enrollment history information concerning the student's dates of enrollment certified by the school. The enrollment history further includes the student's status (full-time or part-time), his/her status when the student first started at the school, the beginning of term date, the end of term date, the student's anticipated graduation date, the school's code, and the school's name. A further aspect of the information pertains to the degree data. This data can be provided on-line, or on an official certificate that the requester can receive. Information included in the student degree history reports are: the name on the school's records, the date the degree was awarded, the title of the degree, the official name of the school, the major and minor courses of studies or options or concentrations, academic or other honors, and the attendance period(s) of the student.

The information reported out by the Clearinghouse 100 concerns three types of services available to the institution. The first is the deferment and electronic notification history. This history is a list of the data that has been reported to a lender, servicer and/or guarantor. Information included in this list include the date the information was sent, the student enrollment status that was reported, the date the status was first started, the anticipated graduation date, the type of notification (e.g., “paper”, “electronic”, “facsimile”) and the member name or recipient of the data.

A second feature relates to information reported out by the Clearinghouse 262 involving NSLDS/SSCR notification history. This history pertains to the national enrollment reporting functions that the Clearinghouse and the universities or colleges are required to report to agencies or departments of the federal government. The National Student Loan Data System (NSLDS) and the Student Status Confirmation Report (SSCR) can be routinely reported to the federal government by the Clearinghouse 100. Information provided on a per student basis to the university include the dates that this data was sent by the Clearinghouse 100 to the Federal Government, the member name to whom it was sent (e.g., NSLDS or SSCR), and the re-enrollment status that was reported-out (full-time, part-time, withdrawn), the date the student first started at the school, the anticipated graduation date, and the SSCR school code. This data is required to be reported on a periodic basis to the U.S. Department of Education. Therefore, the “date sent” data indicates the periodicity of the Clearinghouse's reports.

The history of degree-verify and enrollment-verify activities is also provided on a per student basis. This history, similar to that described in function 212 provides the university on a per student basis with the dates that degree and enrollment information is sent out by the Clearinghouse 100 to members or other requesters.

Element 212 under the student query 210 includes a list of loan holders. This list describes the name of each lender for an identified student, a website address, and a customer's phone number. This list is used only for those loan holders that are members of the Clearinghouse. It is anticipated that the present invention can include all lenders whether those are listed or not. The school inquiry 204 is designed to provide schools with historical information of data transmissions processed by the Clearinghouse. The first of these transmissions is the schedule of future transmissions to the Clearinghouse 220. The information in this schedule includes a beginning date and an end date, the type of transmission (first, subsequent, first of term, etc.), the scheduled transmission date, the received date, the transmission status and an analysis from the Clearinghouse 100 agent who is assigned to work with the school on the various transmissions.

The transmission schedule 224 allows the school to determine in advance its calendar of information transmissions to the Clearinghouse. The school can also check its transmission history of data processed by the Clearinghouse 222. That history includes the scheduled transmission date, the certification date, the received date, the processed date, the academic term, the beginning term date, the term ending date, and the transmission type. The school can also look at the processing details to find out more about how the data was handled for a given transmission. A list of the NSLDS and SSCR information processed by the Clearinghouse is provided at step 224. This history includes whom the data was processed for (NSLDS or the SSCR), the SSCR creation date, the Clearinghouse received date and the Clearinghouse processed date. Finally, at step 226 a list of the contacts at the institution provided to the Clearinghouse are shown. The Clearinghouse will contact these individuals regarding questions on degrees and enrollments.

The enrollment search 208 includes a loan reporting function 234 which provides academic institutions with information about students who applied for or received loans, grants, or other financial aid. Requesting institutions, for example, can use this information 234 to assist in the administration of student financial aid. Examples of the uses of this information includes: deferring Perkins loan repayments, responding to student inquiries regarding loan deferment, cohort default rate verification and challenges, institutional applications for additional work study funding, and institutional applications for additional Perkins loan funding. The information is entered using a student's social security number and/or date of birth. A further feature of the loan reporting function 234 is receiving financial aid information from siblings and/or parents of the students 236. The information 236 is important since it provides a needs analysis contained in the student's application for financial aid. In this example, the social security number, and the name and the date of birth of the sibling or parent for whom the institution is seeking enrollment information for financial aid purposes is provided.

Finally, the Clearinghouse will provide reporting assistance to its college and university members under the Taxpayer Relief Act of 1997. In this instance, the member chooses a vendor to process compliance forms for printing and mailing to students and filing electronically with the federal agencies. The Clearinghouse will then run a program at the end of the calendar year (not shown). The program will produce a consolidated file containing the names, SSNs, addresses, highest enrollment statuses, and “graduate level indicators” of all students who attended the member's institution during the calendar year. The report of the member's consolidated calendar year records will then be transmitted to the vendor, for mailing to the enrolled students, and for filing with the IRS.

Referring back to FIG. 1, the colleges and universities function includes a non-secure portion of the website 110 shown in FIG. 8. The elements of the non-secure website are primarily informational or include demo versions of the functions provided on the secure side of the site 112. That information includes Clearinghouse service descriptions (degree verify 206, enrollment verify 212) and a description of other course services 810. In addition, enrollment search 208 is discussed and a demo is provided for the end user. A copy of the website participation agreement 812 is also provided.

The student's side of the website 104 includes both secure and non-secure functions 130 and 132 respectively. The secure side of the site is shown in more detail in FIG. 6 as process 170. At step 610, the student can choose loan information by employing the loan locator function. To enter the function, the student would first enter his/her social security number and birth date at 612. Once that information is verified, the Clearinghouse 100 will then provide at step 614 information relating to the identity of the student's primary loan contact (contacts) that participate in the loan locator service. The loan information search relies on a lender database 630 that is maintained by the Clearinghouse 100. The locator looks at three types of information: a global inquiry of in-process loans 650, 652, a global aggregation of the principal's default status 654, 656 and lender guarantor information. The answer on guarantors can be retrieved (denoted by the dotted lines) from data sources 660 and 662 respectively.

The student can also verify at 620 his/her enrollment with the enrollment verify option 620. The student can determine whether a secure online service from the Clearinghouse 100 can quickly and efficiently provide education records. To determine if the service is relevant, the student first types in a list of schools to find out if their school participates in the enrollment verification 622. That information will include their school's name as well as the non-member or corporate account member's fees for use in the enrollment verify process. The student then has to identify whether or not they have a credit card or they already possess a password. If they have a user ID and password, they can go to the secure side of the website. (130 on FIG. 1). If not, the student can go to the non-secure side 132 to provide the credit card information for the enrollment verification steps (not shown). Otherwise, the features of the secure and non-secure sides are the same.

At step 624, the student provides information that allows for the electronic verification of his/her enrollment to commercial providers of student services. This service is primarily designed for use with credit assurers, employers, insurance companies, travel companies, and various other businesses that offer products or services based on an individual's status as an enrolled student. Verifications are provided to the end users 24 hours a day, seven days a week via the Clearinghouse website 100 (FIG. 1).

A further feature is deferment information and processes. Periodically, schools report semester enrollments for its students to the Clearinghouse 100. Once this information is received by the Clearinghouse 100, it can in turn distribute the enrollment verification information electronically to its members. In addition, the Clearinghouse can process student loan deferment forms that were received from the school. Many of the members of the Clearinghouse 100 can participate in a paperless deferment process 630. Under process 630 the student can post a deferment to his or her account after the school's verbal order is matched with the Clearinghouse's electronic data verifying in-school enrollment status. The student then clicks on the specific lender lists to see if the lender participates in a paperless deferment. Once that information is received, the student can then apply on-line for his or her own deferment according to the rules set forth in the pertinent lender website, or otherwise according to the lender.

The student website includes information on participating schools 640. These schools can be selected by a variety of sort criteria. Those criteria include, school name, state, school code and the month and year that the student was enrolled.

Returning to FIG. 1 the commercial verify portion of the website 106 provides two principal services to companies and other institutions: pre-employment verifications of degree status and enrollment verifications.

The degree verify function 116 is applied to those universities that agree to participate in degree verification. Degree verify is provided on two bases: to secure users 126, (for those companies that have a user-ID and password), and to non-secure users 128, for those companies that would like to perform verifications and pay for those verifications using credit cards. Other than processing payments, both secure and non-secure degree verify options operate identically, except that companies need to execute an on-line click wrap contract 192. Accordingly, only the secure side functionality will be shown. The degree verify function is then activated at step 126, the steps of which are shown as process 190 in FIG. 5.

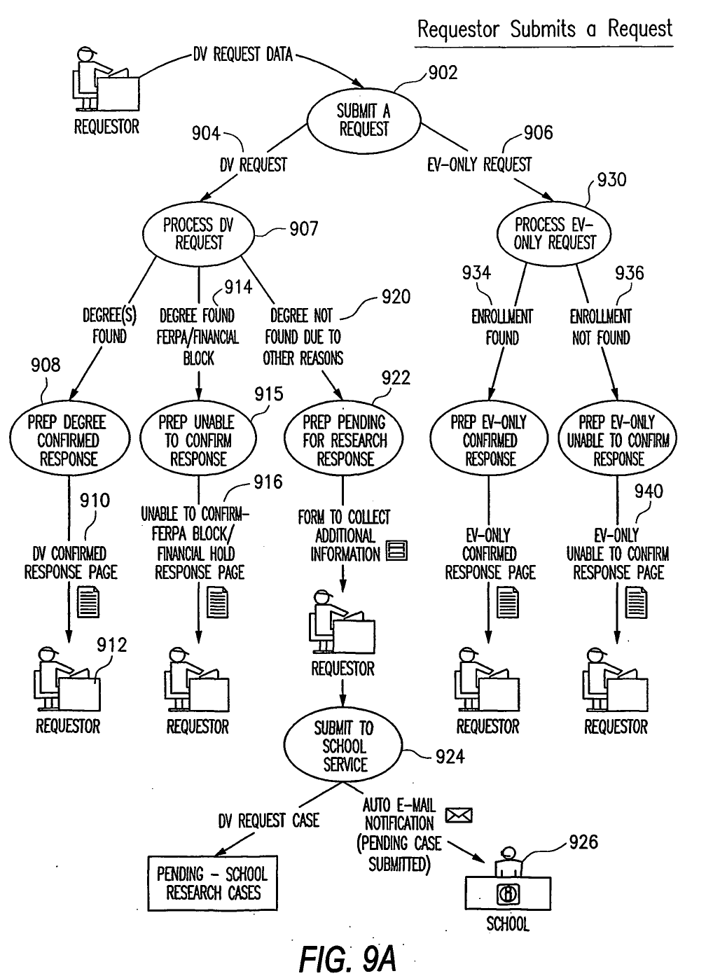

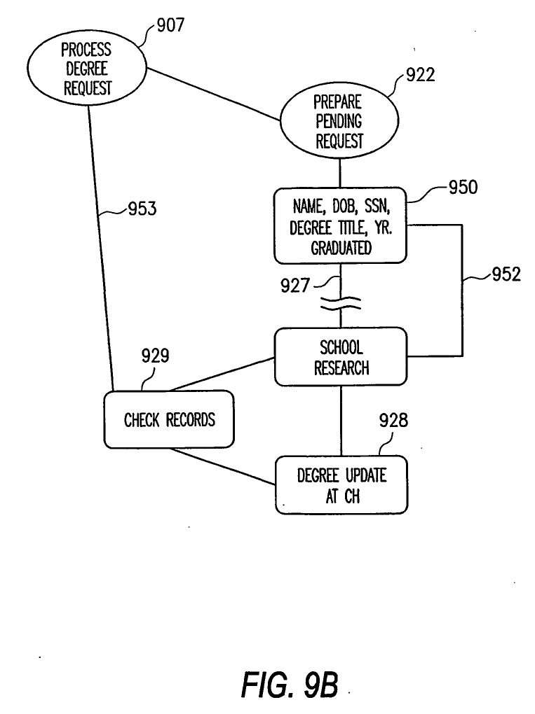

Once the password and user name are verified, then the verification screen for degree verify is provided. A quick draft contract is first sent to user, which upon acceptance, then queries the user for a verification request input at step 502. The user then selects a school, the name of the subject at the school, the student's major, his or her date of birth, social security number, as well as the street name. The secure verify function 504 is then activated. The functions of secure verify request are described in further detail in FIGS. 9A, 9B.

Several administrative functions also need to be performed. First, an agreement for all requestors may need renewal at 506. This process involves verifying that the subject of the research consents, confirming the consent, storing the consent in the Clearinghouse database 510, as well as storing the consent remotely at an individual computer 512.

The enrollment process also includes setting up an executive billing contract for the requestor at 514. Once this is done, the requestor is asked to identify a school at step 516. School information can be performed by a list look-up of pre-stored degree certifying institutions found in database 518. Personal information about the subject is the requested at step 518. While the requestor is prompted to enter alias 520 or other change of name information 524, such information may automatically populate the verification request fields upon entry. The process then checks the information and confirms its accuracy 530 or that the entered information is not complete or correct 532, in which case, the applicant returns to the school side to obtain verification/confirmation of his/her information on 536. Personal information and degree information are stored respectively in the personal information database 540 and degree database 542. However, any combination or arrangement of databases is acceptable.

In Referring to FIG. 9A, the degree verification request is submitted by the requestor 106 at step 902. There are two types of requests in the degree verification service that are processed: a degree verify request 904 or an enrollment verify request 906. If the degree verify request 904 occurs, then that request is processed at step 907 by the Clearinghouse 100. There are three types of results to the degree verify request 906: the first result, 908, is that the degree is found by the Clearinghouse 100. In this instance, the process is simple: a degree confirmation response is provided to the requestor 106 which can be sent out to the website, or provided as a confirmation page 910, or mailed, faxed, or provided by another means of communication. The information provided in the response 910 is the school name, the name of the student, the name of the student when attending the school, his or her date of birth and social security number. The verification request is then summarized so that the requestor can confirm its accuracy. If a data entry error is found, the requestor can at this stage edit the request. After the requestor has confirmed that the information is essentially correct, then the request is submitted. The verified information in the request includes the date the degree was awarded, the degree title, the name of the school issuing the degree, the major courses of study, and the student's attendance dates.

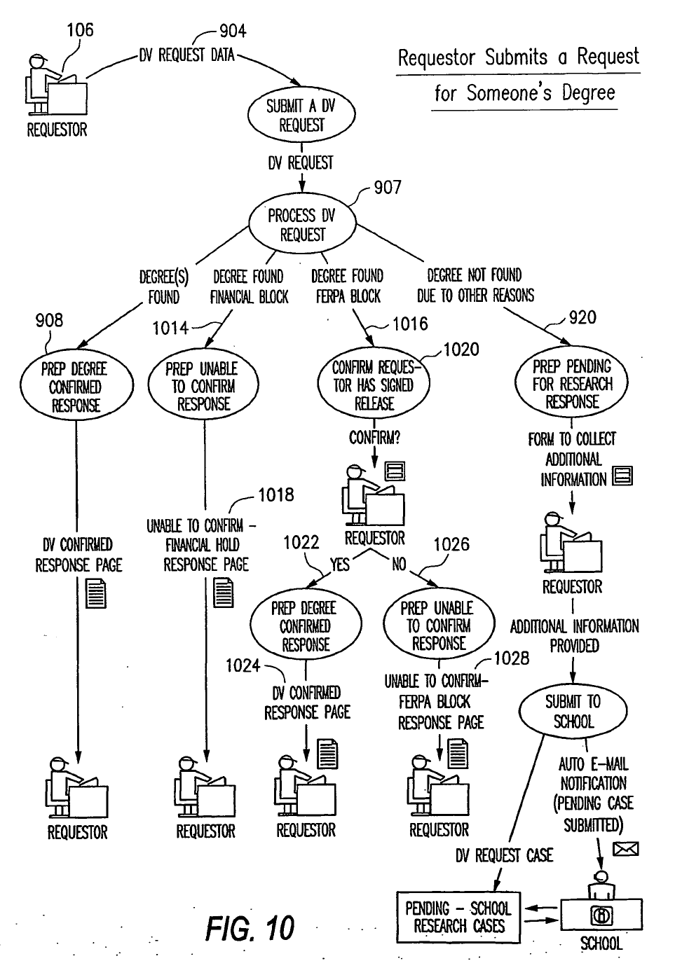

Another result of the degree verify process is that the degree has been found but is unavailable due to a FERPA or financial block 914. In either instance, verification data is available to the Clearinghouse, but may not be made available to the end user 915. Also, in both cases, the verification response at 916 is initially a message indicating that the Clearinghouse is unable to confirm information for this individual. However, the next step differs between a FERPA block and a financial hold. That difference will be described in further detail in FIG. 10.

At step 920 a degree is not found due to reasons other than a FERPA or a financial block. In this instance, at step 922 the pending request is sent to the school for off-line validation and research 924. A system-generated email will then be sent to the school, 102 and to the requestor 106. To the school, the email 924 will indicate that a request was submitted for verification of the degree and enrollment history. A transaction ID, date requested, and member name is given to the school. The subject is name, school and date of birth is also provided to the school for verification. Finally, the school will receive the user's social security number and the reported degree award year. At this point 926, the school can then process the data at step 922 as shown in FIG. 9B. Each line of the data is then double-checked against the school's records either manually or by computer. The school then will send its results back to the Clearinghouse 100 at step 928, where the official degree database is updated. If questions still remain to be resolved, records are checked and follow-up communications between the school and the Clearinghouse occur at step 929. Once that the Clearinghouse has verified the record and updated it, an email is sent to the original requester 953 providing the updated degree verification information.

Referring to FIG. 10, it should be noted that a financial block and a FERPA block are different. For a financial block, the school is responsible for establishing, maintaining and canceling the financial block. Usually a financial block results when money is owed to the school and the school is unwilling to supply its records until the financial block has been removed by the student. In this instance, the user cannot override the block. Instead, the user has to go directly to the school to work out whatever problem exists before the request can be processed. Thus, when a financial block is uncovered, the request is closed. A FERPA block, on the other hand, involves an instance where the student opts to say “No” to providing his or her enrollment or degree information to a third party requestor. It is in essence a privacy block. However, as will be described further in the later figures, the user can override this block. This may be done online or via facsimile, depending on whether the requestor is a secure-side member (password protected) or a non-secured requester.

Returning back to FIG. 9A, the degree verification function 902 also allows enrollment to be verified 906 either for a subject who has applied for, but not yet received, a degree, or to verify attendance only for a subject who has not received or applied for a degree. The enrollment verification request 906 is sent at step 930 to the database at the Clearinghouse 104. If an enrollment is found, the information is displayed at step 934 in an information verified screen. This screen shows the requestor 106 the date enrollment was verified by the school, whether the student was or was not enrolled, the beginning term date and the ending term dates of enrollment, as well as the name of the school attended. If no enrollment information is found at 936, an “unable to confirm” report is provided to the requestor. A variety of reasons are provided regarding why the enrollment was uncovered at step 936. Those reasons include that the subjects' enrollment predates his or her institution's participation in a database, the subject has never been enrolled at the identified school, the subject's name and/or date of birth do not correspond to the name or date of birth provided by the school, the subject has elected to keep his or her records private (e.g., FERPA block), or the subject's academic credentials could not be verified due to an outstanding financial obligation. An “unable to confirm” notification such as an e-mail or website message is then sent to the requestor at step 940.

FIG. 10, is a flow detailed view of the degree verify request 904. As shown, the submitted request is sent to the Clearinghouse 100 which then accesses the portion of its database(s) containing information from those schools that agree to participate in the degree verify portions of the service. As previously noted, the degree verify schools tend to be a subset of the total database of participating educational institutions. This is because many more schools sign up for the enrollment verify function, as provided to commercial companies, which is in turn a subset of a far larger number of schools which agree to provide enrollment information solely to guarantors, lenders, or loan servicers.

Step 914 from FIG. 9A is now divided into two steps 1014 and 1016. At step 1014, a degree is found but a financial block also is uncovered. Because the school is unable to remove on-line the financial block, it is unable to confirm any information. An “unable to confirm” message due to a financial hold is then sent to the requestor 106 and the financial hold response page is then given to the requestor at step 1018. On the other hand, if a degree is found, but there is a FERPA block 1016, the website automatically queries the requestor whether or not a release has been signed. There are two types of queries that can be made. If a requester is a member, they are merely presented with a check box where they can indicate a “Yes” or “No” regarding the waiver or FERPA release. If they check the “Yes” at step 1022, then a degree confirmation response is prepared and a response page is provided at step 1024 to the requestor 106. If a non-member is asked about the signed release, they must then fax or provide evidence of the signed release to the Clearinghouse in some other fashion at step 1022. At step 1024 the confirmed response is then sent. If it is known that no FERPA request has been released, then an “unable to confirm” response is provided to the requestor at steps 1026 and 1028. Enrollment not found step 920 is similar to that previously described with respect to FIG. 9.

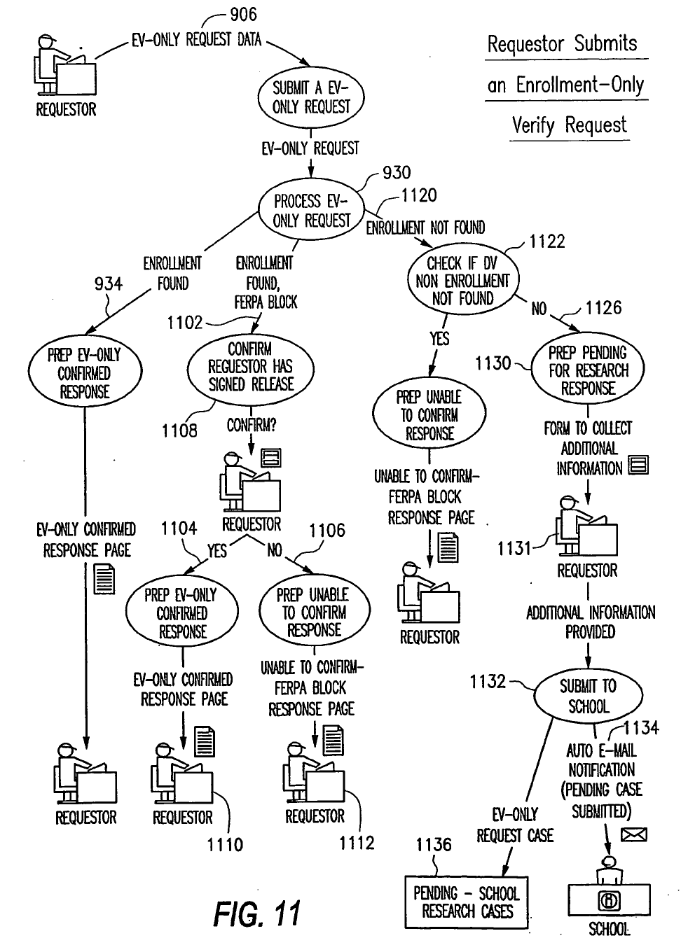

FIG. 11 is a detailed flow diagram that shows the use of the system for enrollment verification 906. The verification request 906 is submitted by a requester 106 to a processor 930. The enrollment verification data, as previously noted, can incorporate two databases including both degree institutions and the non-degree record institutions which allow their data to be used by the commercial requestors 106. Four potential answers to a request 906 can be provided. The first possibility is that the student's enrollment is found at step 934. The process for notifying the requestor of this enrollment data is the same as set forth in FIG. 9.

If a FERPA block exists at 1102, the requestor 106 then receives a message that enrollment information cannot be confirmed. The system then asks the requester to confirm whether or not a release has been signed at step 1108. As previously noted in FIG. 10, the FERPA waiver is verified differently, depending upon whether the requester is a password-protected secure member, or not. At steps 1104 and 1106, the enrollment verification information is provided depending upon whether or not a confirmed release has been determined at 1108. The response pages are then respectively printed out to the requester at steps 1110 and 1112.

At step 1120 a test is applied when the enrollment record is not initially found. In this instance, a check is made to see whether or nor the school is a degree verification school at step 1122. If the answer is that the school is a non-degree verification school, then a response is prepared indicating that it is unable to confirm whether or not a release has been signed for a FERPA block. This is because this school is not a school which can process FERPA releases. On the other hand, if the school is a degree verification school, 1126, a request for research is sent to the school 1130 and a form is provided to the requestor at step 1131 requesting additional information. The additional information request 1131 includes an automatic email notification at step 1136 indicating that the answer is pending while the school researches the case. The school and the Clearinghouse 100 then communicate with one another (not shown) mutually updating the enrollment information. Once updated, and/or corrected, that information is sent back to the user in an email from the Clearinghouse.

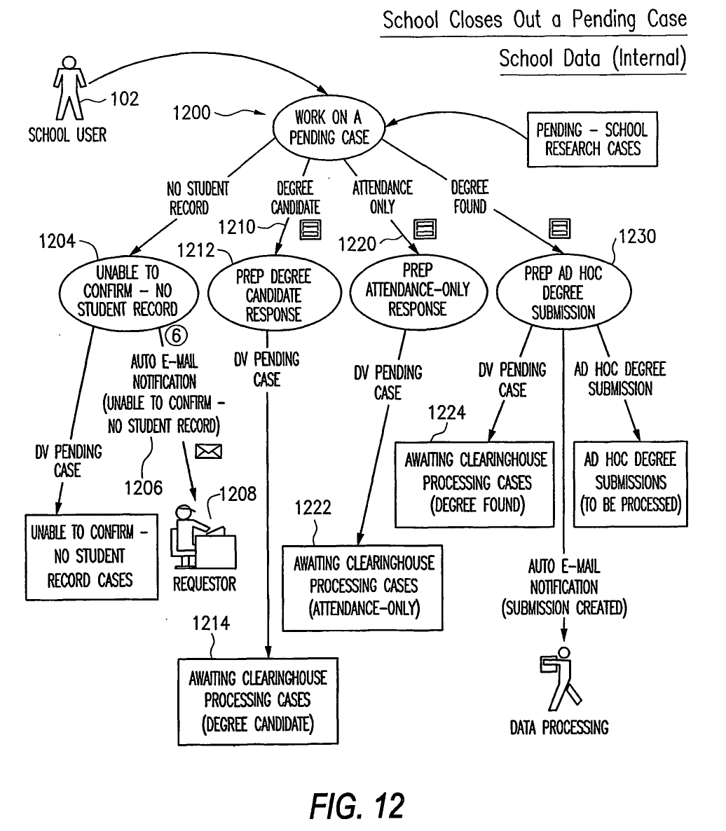

Referring now to FIG. 12, further detail is provided in a flow diagram with regard to the steps that the school or institution 102 must take in order to work on pending cases 160 that are referred to the school for further research. There are four kinds of work on a pending case 1200 that the school 102 performs. The first type of work occurs when the Clearinghouse 100 accesses the school database (whether directly or indirectly) 1204 and is unable to confirm the existence of a student record. When the Clearinghouse system 100 is unable to find a requested record, it automatically sends an email notification 1206 to the requestor as well as to the school 102 indicating that there is no record. The school then will close the case at 1208 and no further work will be done on the matter.

Another form of a pending case is where degree candidate information is requested from the Clearinghouse 100 at 1210. In this instance, the school prepares a degree candidate response at step 1212. While that degree information is pending, an email is sent to the requestor indicating that it is awaiting Clearinghouse processing of the case for a degree candidate. The school then reads the case, populates the Clearinghouse database whereupon an automated email notification is generated that Clearinghouse processing is underway.

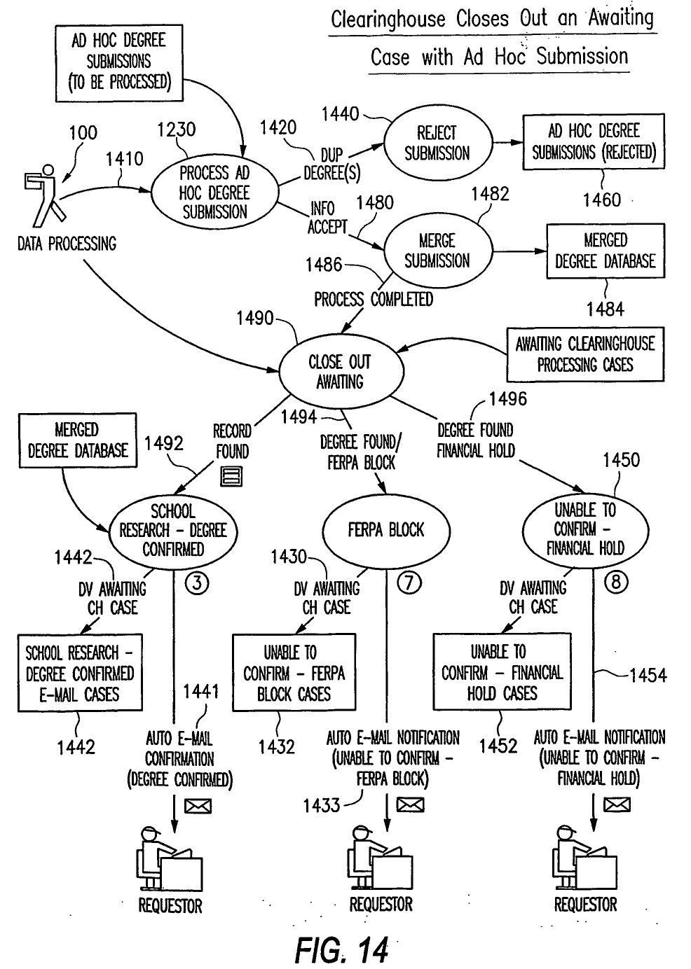

At step 1220, an attendance-only request is made to the school. Again, the Clearinghouse will send a message to the requestor at 1222 indicating that the Clearinghouse is processing the case. Automated email notifications to the school and then back to die Clearinghouse occurs, while the school processes the attendance request at step 1224. At step 1230, a degree is found and an ad hoc degree submission process occurs by the school. In an ad hoc scenario, the school has read the case and populates what is otherwise a missing degree entry on the Clearinghouse database. Further details regarding ad hoc degree submission are provided in FIG. 14, described below.

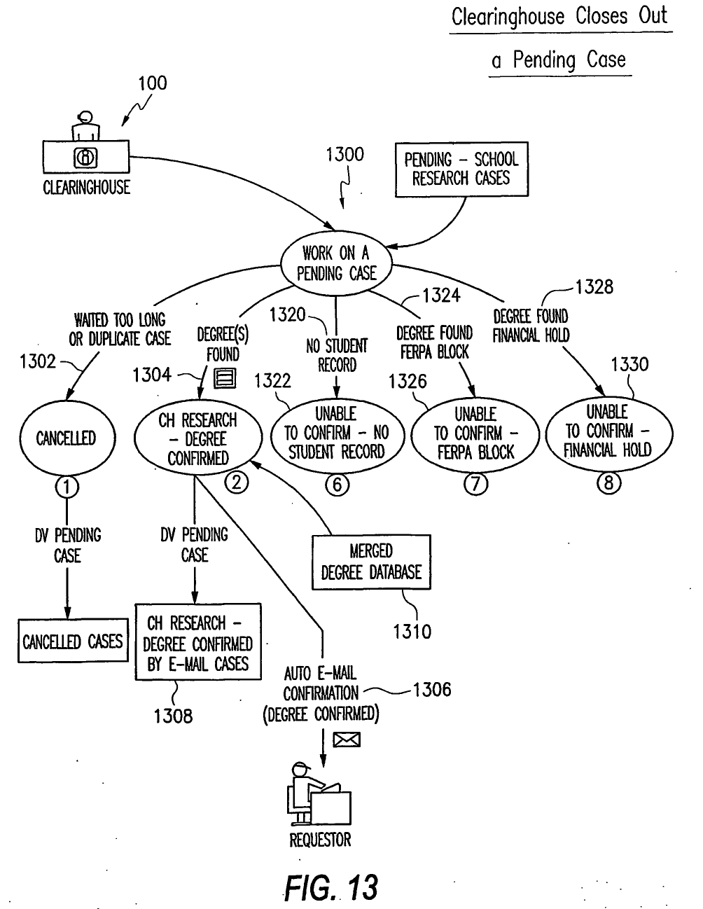

FIG. 13 is a flow diagram of the offline work flow that occurs at the Clearinghouse 100 in order to close out pending cases. As shown, the Clearinghouse 100 has seven types of pending cases, each of which can be processed through a computerized work process or, through a combination of computer and manual steps. At step 1302, there is a pending case upon which the time period has simply been too long. In this instance, no degree verification can be found, either by the Clearinghouse 100 or by the school 102. An email is then sent to the requester indicating that no degree has been found, and the case is closed or cancelled. In the second type 1304, a degree is found through a merged degree database. In this instance, an associated correct record is matched to a request. A good example of such an instance is where a name has changed and the correct degree is matched to a corrected name. An auto email confirmation is then sent to the end user, or requestor at step 1306. However, a name is not changed in the record for the degree at 1310 inasmuch as it may corrupt the correct name tables at the time the degree was issued. The case is then closed.

At step 1320, no student record is found. At 1322 an email message is sent indicating that the Clearinghouse 100 is unable to confirm the student record because one was not found. Very often this involves a wrong school. In such an instance the Clearinghouse will provide a hint to the requestor, (such as to call them and suggest that they try to reconfirm the name of the school). The situation at step 1324 involves an instance where a degree is found but a FERPA block remains. A certain period will be assigned to wait for the waiver of the FERPA block by the student. If, however, the Clearinghouse 100 is unable to confirm a FERPA block waiver at 1326 after a preset time period, then the request will time-out and the Clearinghouse 100 will cancel the request. Upon cancellation, the Clearinghouse will notify the end user that it is unable to confirm due to a FERPA block. Step 1328 represents a case where a degree is found but a financial hold condition is maintained. In this instance, a message is sent to the requester indicating that the Clearinghouse 100 is unable to confirm the degree due to a financial hold. The case is then closed by the Clearinghouse.

FIG. 14 illustrates how the Clearinghouse 100 treats a case that involves an “ad hoc” submission by the school 102. As mentioned with regard to FIG. 12, an ad hoc submission involves a situation at 1230 where a degree request occurs and the Clearinghouse 100 has no record or has a problematic record. At step 1420 the ad hoc degree submission uncovers that the Clearinghouse data base has a duplicate degree. As a result, at step 1440 the submission is rejected since it cannot be correct and a message is then sent to the school 1460 indicating that the degree submission cannot be correct. At step 1480, information is provided from the ad hoc degree submission at the school, and is accepted by the Clearinghouse. At 1482, the database is merged whereby the Clearinghouse 100 loads into its database correct information after checking it out (usually with some offline email interaction between the Clearinghouse and the school). An email message is sent at 1484 to the school 102 indicating that the merged database step has occurred, and the record has been updated. The process is then completed at 1486 and the database processing side of the ad hoc submission is closed at 1490.

Once the database updating steps have been completed at 1490, then automated email (or other form of communication) reports are made to the requestor. There are three forms of reports: (1) a record is found at 1492, (2) a degree is found but there is a FERPA block at 1494, and (3) a degree is found but there is a financial hold at 1496. In the instance where the record is found at 1492, the system indicates to the end user that the Clearinghouse database is being updated and the degree verification is awaiting at 1442 confirmation by the Clearinghouse. Once the school research is confirmed by the Clearinghouse at 1444, an email message is sent to the requestor at 1441 and to the school at 1442 indicating that the database has been updated and the record confirmed. The Clearinghouse 100 then closes out the case.

In the instance of a FERPA block at 1444, tests occur to confirm a FERPA release waiver at step 1430. If no FERPA release is received at 1432 a message is sent to the school and at 1433 the requester is notified that there is a remaining FERPA block. If the release is signed, either by incoming fax or by checking a dialogue box on the website as previously discussed, then the degree verification information is released and sent to the requester. An updated confirmation is also provided to the school or institution. Finally, if the degree is found but a financial hold remains on the record at step 1496, then an unable to confirm financial hold message 1450 is sent to the school 1452 and to the requester 1454.

FIG. 3 illustrates the services and functions available to guarantors, lenders, and servicers 195 of FIG. 1. While the secure side of the site 195 is illustrated in this block flow diagram, it should be noted that the non-secure lender 120, once signed-up, will be able to perform the same functions.

The lender site 195 has three functions/services available to the registered lender/guarantor. The first is the student query group 304. To access the query, the lender 108 must enter at 310 the student's social security number. The lender 108 then has three types of queries they can perform: current enrollment data 312, enrollment history 314 and notification history 316. If the current enrollment 312 is chosen, then the lender receives a chart for the student. The chart identifies the student by name, address, the date their enrollment was certified by the school, the student's enrollment status (e.g. fill, part-time, withdrawn), and when the term begins and ends. The chart also includes the school name, anticipated graduation date and the school code. Finally, the next scheduled enrollment transmission date is reported.

The enrollment history, reports the same information as current enrollment, except it provides a row for each report date by the school, and for the student's prior school. The lender 108 thereby sees the entire enrollment history for the student.

The notification history 316 indicates which lender by name receives enrollment data, and when that enrollment data was sent to the lender.

The second function group available to the lender 108 is the school query 320. The school query function is first opened by entry of the school code or branch ID number at step 322. Three functions are then provided: schedule of future transmissions to the Clearinghouse 324, history of transmissions processed by the Clearinghouse 326 and history of NSLD SSCFS processed by the Clearinghouse 328.

The transmission schedule 324 indicates the scheduled dates of transmission, the term dates covered by those transmission, the transmission type (e.g. first term, summer term, subsequent of term), the received date and the transmission status.

The history of transmissions processed by the Clearinghouse 325 includes the scheduled date, certificate, received and processed dates, and the academic term covered (including term end and begin dates and the transmission type).

Finally function 328 lists who the SSCR was processed for (e.g. NSLDS, SSCR) the SSCR creation date, the Clearinghouse receive data and processed dates.

The third function involves late reporting schools 330. To use this function, a state must first be selected at step 332. Then the late reporting data can either be sorted by delinquency 334, state-wide 335 or by school code 336.

FIG. 4 shows the enrollment verify functions and processes for the present function 180. Upon entry, the requestor 106 is provided with a verification request information query 410. The requestor is then prompted to select a school name, a subject name, a name when attending the school, the date of birth and the social security number.

At step 412, the system then provides the information stated, including the dates of enrollment. Certain school analysis 440 can also be provided. That analysis includes enrollment data after the student has left 450, enrollments at other schools of students who declined their admissions to an identified school 460, and a reporting aggregate for an identified institution 470. If no information is found, an unable to verify screen 480 is provided.

FIG. 7 illustrates the non-secure side functions and process 197 for guarantors, lenders and servicers 108. Upon entry to the site 197, the lender 108 is provided with information on how to join the Clearinghouse 710. Included in the Clearinghouse description is a list of the participating schools 720. This list is sorted either by a school name, by state, by a school code or by month/year participated in the Clearinghouse service. Before joining, the lender, guarantor or servicer also is provided with a service agreement, which can either be accepted on-line, or off-line. Once the agreement and participation fees are accepted, then the lender, guarantor or servicer 108 is referred to those secure-side functions 195 (FIG. 3).

The above degree information and enrollment information can be applied to any kind of educational institution, whether college, university, trade school, secondary or any other public school information. Under such a system, virtually every degree can be verified and degree fraud and misrepresentation is completely removed. Schools will also be able to fulfill their obligations to verify degrees without incurring expensive staff time interruptions or other disruptions to their work flow.

Although the present invention has between described in connection with the preferred form of practicing it, those of ordinary skill in the art will understand that many modifications can be made thereto within the scope of the claims that follow. Accordingly, it is not intended that the scope of the invention in any way be limited to the above description, but instead be determined entirely by reference to the claims that follow.

What is claimed as new and desired to be protected by Letters Patent of the United States is:

1. A method for communicating confidential educational information comprising:
receiving information from colleges and universities and guarantors and lenders;
receiving requests for degree or enrollment information from requesters both from the student and lenders side and from the commercial side;
comparing said requests for degree and enrollment information with a first database located at a Clearinghouse;
for comparing said requested information with a second database located at a school or university, and
providing data matched to said request to a requestor.
